(19) United States
(12) Patent Application Publication
(10) Pub. No.: US 2006/0124678 A1
(43) Pub. Date: Jun. 15, 2006

(54) Roof rack and method of using same

(75) Inventor: Donald W. Wooten, Dallas, TX (US)

Correspondence Address: DUNLAP, CODDING & ROGERS P.C., PO BOX 16370, OKLAHOMA CITY, OK, 73113, US

(73) Assignee: Tactical & Rescue Equipment, LLC

(21) Appl. No.: 11/010,457

(22) Filed: Dec. 13, 2004

(51) Int. Cl. B60R 9/00

(52) U.S. Cl. 224/326; 224/317; 224/329

(57) ABSTRACT

A removable roof rack connectable to a roof of one or more different vehicles, the roof having a front edge and a back edge, the roof rack having one or more support members and a means for engaging the front edge and the back edge of the roof. The support members are capable of supporting a load and are aligned in the direction of the movement of the vehicle. One or more lateral supports, connectable to the support members may directly support the load.

### CROSS-REFERENCE TO RELATED APPLICATIONS

Not applicable.

### STATEMENT REGARDING FEDERALLY SPONSORED RESEARCH AND DEVELOPMENT

Not applicable.

### BACKGROUND OF THE INVENTION

Roof racks add additional cargo capacity and are useful for transporting cargo. For military vehicles in particular, roof racks can provide a valuable place to stow personal gear such as duffel bags, as well as other material such as water, ammunition, concertina wire, etc. Some roof racks are permanently attached to the vehicle with any removal causing damage. Other roof racks are removable without noticeable damage. Since different vehicles have different roofs, some roof racks are removable and adaptable to fit different vehicles. These roof racks typically stretch from one side of the roof to the other, covering much of the roof and connecting to the rain gutters or the door frames. The support members of such roof racks stretch from one side of the roof to the other, perpendicular to the directional movement of the vehicle. This arrangement causes undesirable wind resistance, lowering fuel efficiency, creating noise and causing instability. These drawbacks occur when the roof racks hold cargo as well as when they are empty. This problem has been addressed to some extent in permanent roof racks. Some permanent roof racks have support members aligned in the direction of the vehicle movement. However, these roof racks cannot be moved readily from one vehicle to another. They cannot even be removed from the vehicle and replaced later without leaving damage, such as holes, chipped paint, residual glue, and the like.

It is desirable for the support members of a roof rack to run in the same direction as the movement of the vehicle, without any permanent alteration to the vehicle. However, the support members of removable roof racks run perpendicular to the directional movement of the vehicle. Thus, a removable roof rack having support members aligned in the direction of the movement of the vehicle is needed.

### BRIEF DESCRIPTION OF THE SEVERAL VIEWS OF THE DRAWING

FIG. 1 is a perspective view of a roof rack, constructed in accordance with the present invention, mounted on a vehicle.

FIG. 2 is an exploded, perspective view of the roof rack depicted in FIG. 1.

FIG. 3A is a top plan view of a support member constructed in accordance with the present invention.

FIG. 3B is an end view of the support member of FIG. 3A.

FIG. 4A is a top plan view of a front anchor assembly constructed in accordance with the present invention.

FIG. 4B is a side elevational view of the front anchor assembly of FIG. 4A.

FIG. 5A is an end view of an anchor spacer constructed in accordance with the present invention.

FIG. 5B is a side elevational view of the anchor spacer of FIG. 5A.

FIG. 6A is an end view of an anchor fastener constructed in accordance with the present invention.

FIG. 6B is a side elevational view of the anchor fastener of FIG. 6A.

FIG. 7A is an end view of an anchor clip constructed in accordance with the present invention.

FIG. 7B is a side elevational view of the anchor clip of FIG. 7A.

FIG. 8A is a side elevational view of a half clamp constructed in accordance with the present invention.

FIG. 8B is an end view of the half clamp of FIG. 8A.

FIG. 9A is a side elevational view of a lateral support constructed in accordance with the present invention.

FIG. 9B is a top plan view of the lateral support of FIG. 9A.

FIG. 9C is an end view of the lateral support of FIG. 9A.

FIG. 10 is a perspective view of an alternate embodiment of the roof rack constructed in accordance with the present invention, mounted on a roof of an alternate vehicle.

FIG. 11 is an exploded, perspective view of the roof rack depicted in FIG. 10.

FIG. 12A is an end view of an alternate embodiment of an anchor clip constructed in accordance with the present invention.

FIG. 12B is a side elevational view of the anchor clip of FIG. 12A.

FIG. 13A is an end view of another alternate embodiment of an anchor clip constructed in accordance with the present invention.

FIG. 13B is a side elevational view of the anchor clip of FIG. 13A.

### DETAILED DESCRIPTION OF THE INVENTION

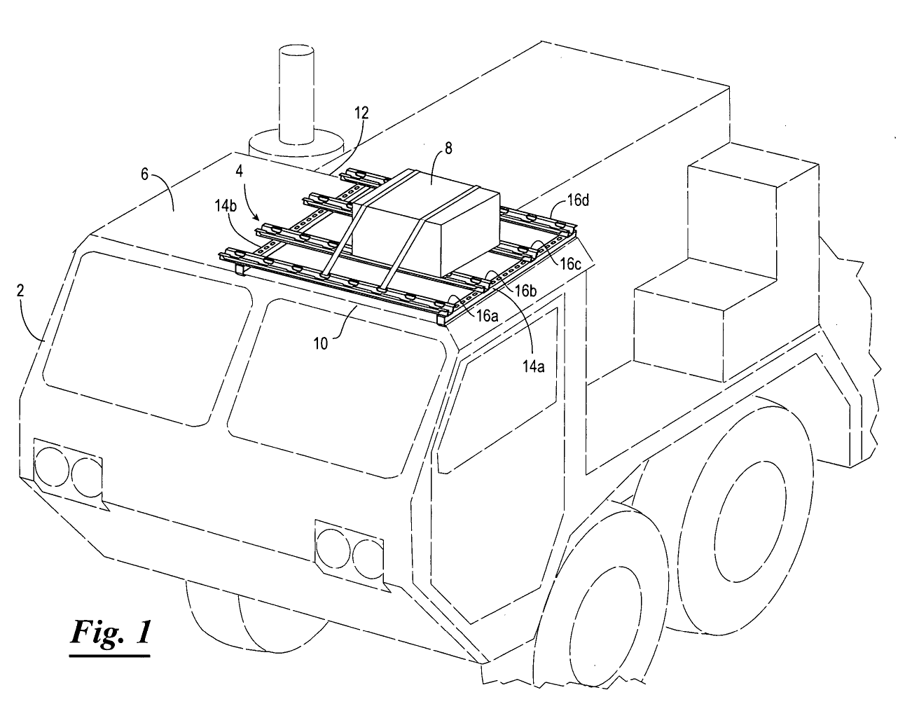

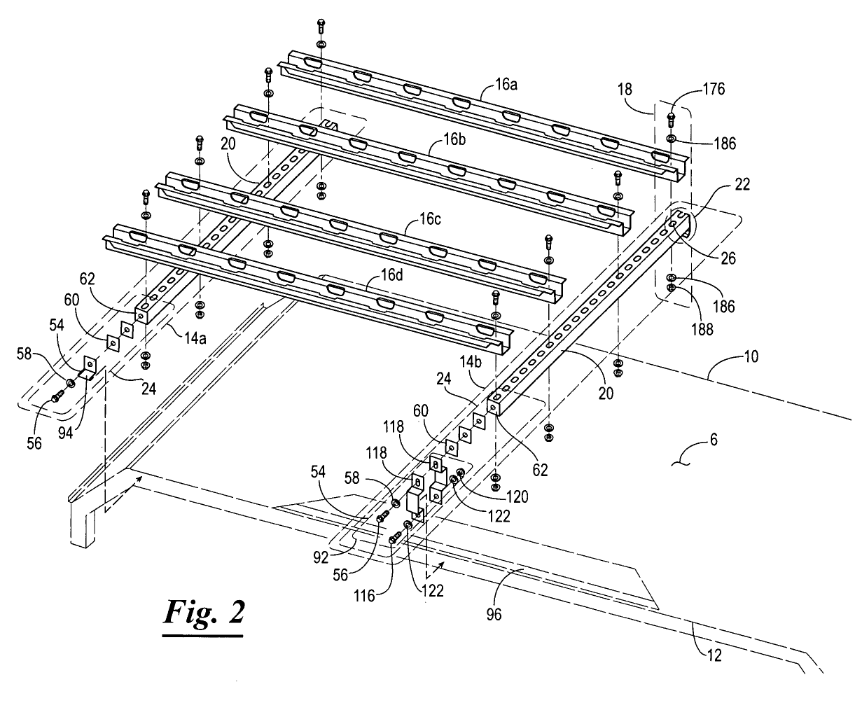

Referring now to the drawings, and more particularly FIG. 1 shows a vehicle 2, such as a Heavy Expanded Mobility Tactical Truck (hereinafter referred to as a “HEMTT”), with a roof rack 4 in place. The roof rack 4 is suitable for any personal, commercial or military vehicle with a roof 6. “Roof” as used herein describes a protective covering or support on top of the vehicle 2, and may be rigid or flexible, permanent or removable, and continuous or non-continuous. The roof 6 frequently serves as shelter, but may also serve as a storage place for a load 8. In order to transport the load 8 on the roof 6, the roof rack 4 is used. The roof rack 4 engages a front edge 10 and a back edge 12 of the roof 6 via one or more support assemblies 14 (identified as 14a and 14b for clarity). The support assemblies 14 also serve to support the load 8 on the roof 6. The support assemblies 14 may directly support the load 8, or may support one or more lateral supports 16 (identified as 16a, 16b, 16c, and 16d for clarity) which support the load 8 more directly. The optional lateral supports 16 support the load 8 and distribute the weight of the load 8 to the support assemblies 14. The lateral supports 16 are connected to the support assemblies 14 via one or more mounting mechanisms 18 (shown in FIG. 2).

Referring now to FIG. 2. The support assemblies 14 each has a support member 20 that distributes the load 8 (shown in FIG. 1) to the roof 6. The support assemblies 14 also each has means for engaging the front edge 10 and back edge 12 of the roof 6. In one embodiment, the means for engaging is a front anchor assembly 22 and a rear anchor assembly 24. However, other means such as glue, magnetism, rivets, suction cups, ties, velcro, weld, and the like will suffice.

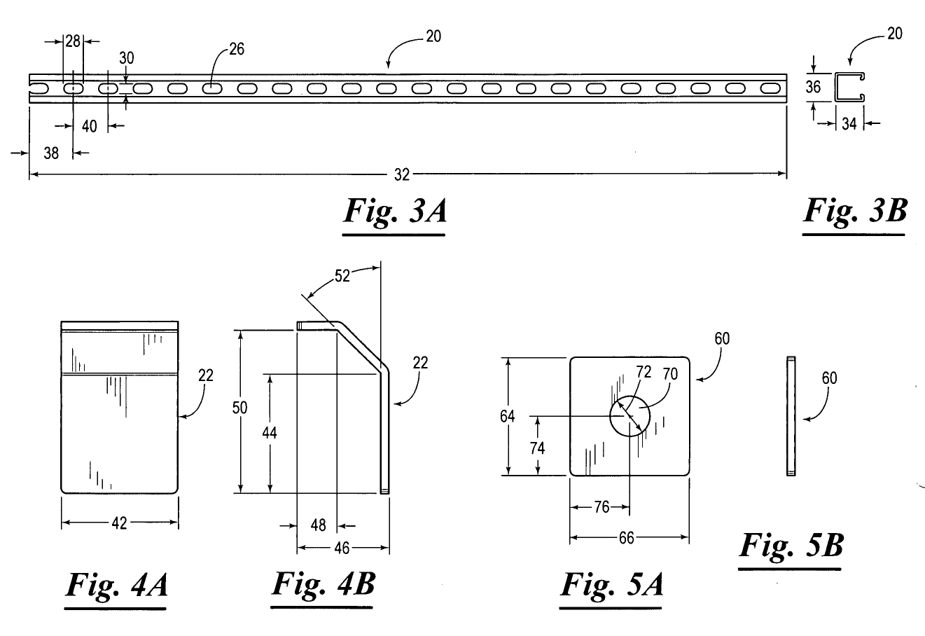

As shown in FIGS. 3A and 3B, the support member 20 is preferably a box-shaped bar constructed of a rigid material capable of supporting a load, such as but not limited to ASTM A653 Steel, 14 gauge. However, other shapes are acceptable, such as but not limited to a circular bar, a triangular bar, a u-shaped channel, a plate, and the like. The support member 20 has means for connection to the lateral supports 16 (shown in FIGS. 1, 2, 9, 10, and 11) in any number of configurations. In one embodiment, this means for connection is one or more mounting holes 26. The mounting holes 26 have a shape suitable for accommodating the mounting mechanisms 18 (shown in FIG. 2), and allowing connection of the lateral supports 16 to the support member 20 (as shown in FIG. 2). In one embodiment, the mounting holes 26 have an oblong shape with a length 28 and a width 30. While the mounting holes 26 are described as oblong shaped, it should be understood that any number of shapes will suffice, including but not limited to circular, square, or rectangular. The support member 20 is shaped such that it is suitable for covering a portion of the roof 6, providing clearance between the load 8 and the roof 6, and providing distribution of the load 8. The support member has a length 32, a depth 34, and a width 36. Additionally, the embodied support member 20 has means for connecting the lateral supports 16. In the embodiment shown, the means for connecting is the mounting holes 26. This embodiment also has an end clearance 38 providing enough space to connect the lateral supports 16, and a mounting hole spacing 40 allowing multiple lateral supports 16 to be connected at various locations along the support member 20. While, mounting holes 26 with an end clearance 38 and a mounting hole spacing 40 are described, other means for connecting the lateral supports 16 to the support member 20 are also sufficient. Examples of other means for connecting the lateral supports 16 to the support member 20 include but are not limited to brackets, clamps, clips, glue, hangers, hooks, interlocking edges, keyed edges, magnetism, pegs, rivets, suction cups, tabs, ties, velcro, welds, and the like. In one embodiment suitable for military vehicles such as the HEMTT or a Palletized Loading System (hereinafter referred to as a “PLS”), the length 32 is 43.50 inches, the depth 34 is 1.63 inches, the width 36 is 1.63 inches, the end clearance 38 is 2.50 inches, the mounting hole spacing 40 is 2.00 inches, the length 28 of the mounting holes 26 is 1.13 inches, and the width 30 of the mounting holes 26 is 0.56 inches.

Referring again to FIG. 2. The front anchor assembly 22 engages the front edge 10 of the roof 6, and is preferably an L-shaped bracket constructed of a rigid material capable of engaging the front edge 10 of the roof 6, such as but not limited to ASTM A653 Steel, 12 gauge. Referring now to FIGS. 4A and 4B, the front anchor assembly 22 has a width 42 and a straight length 44 suitable for connecting to the support member 20 (shown in FIG. 2), an overall depth 46 with a straight depth 48 that provides enough material for connecting to the roof 6 of the vehicle 2, and an overall length 50 and a chamfer angle 52 that allow the roof rack 4 to be connected to the roof 6 of the vehicle 2. While an L-shaped bracket is described, other shapes and configurations are also acceptable. For example, but not by way of limitation, brackets, clamps, clips, glue, hangers, hooks, magnetism, pegs, rivets, suction cups, ties, velcro, weld, and the like are all capable of engaging the front edge 10 of the roof 6. In one embodiment suitable for a military vehicle, such as the HEMTT or the PLS, the width 42 is 1.50 inches, the overall depth 46 is 1.15 inches, the straight depth 48 is 0.50 inches, the overall length 50 is 2.07 inches, the straight length 44 is 1.53 inches, and the chamfer angle 52 is 45°. The front anchor assembly 22 is connected to the support member 20 at one end via glue, weld, or other suitable means.

Referring again to FIG. 2, the rear anchor assembly 24 engages the back edge 12 of the roof 6. In one embodiment, the rear anchor assembly 24 has a roof engaging means 54, an anchoring bolt 56, an anchoring washer 58, one or more anchor spacers 60, and an anchor fastener 62. While this is the preferred embodiment for the rear anchor assembly 24, numerous other means for engaging the back edge 12 of the roof 6 are sufficient, including but not limited to brackets, clamps, clips, glue, hangers, hooks, magnetism, rivets, suction cups, ties, velcro, weld, and the like. In the shown embodiment, the anchor fastener 62 is connected to the support member 20 at the end opposite the front anchor assembly 22 via glue, weld, or other suitable means and serves to receive the anchoring bolt 56. The anchoring fastener 62, and the anchoring spacers 60 are preferably constructed of a rigid material such as but not limited to ASTM A653 Steel, 12 gauge. The anchoring bolt 56 is threaded through the anchoring washer 58, through the roof engaging means 54, through the one or more anchor spacers 60, and into the anchor fastener 62. The anchoring bolt 56 is then tightened to secure the roof engaging means 54 to the roof 6, and to the support member 20. While this embodiment uses the anchoring bolt 56, the anchoring washer 58, the anchor spacers, and the anchor fastener to connect the roof engaging means 54 to the support member 20, any suitable connecting means would suffice. For example: glue, magnetism, rivets, velcro, weld, and the like.

FIGS. 5A and 5B show the anchor spacers 60 are dimensioned to fit properly between the roof engaging means 54 and the anchor fastener 62 (shown in FIG. 2), and to allow the anchoring bolt 56 to pass through. In the embodiment shown, the anchor spacers 60 have a length 64, a width 66, an anchoring hole 70 with an anchoring hole width 72, a length to center 74, and a width to center 76. While the anchor spacers 60 shown have a square-shape with a circular center, other shapes, such as but not limited to a c-shape or a ring-shape are also sufficient. In one embodiment suitable for a military vehicle, such as the HEMTT or the PLS, the anchor spacers 60 have the length 64 of 1.50 inches, the width 66 of 1.50 inches, the length to center 74 of 0.75 inches, the width to center 76 of 0.75 inches, and the anchoring hole width 72 of 0.50 inches.

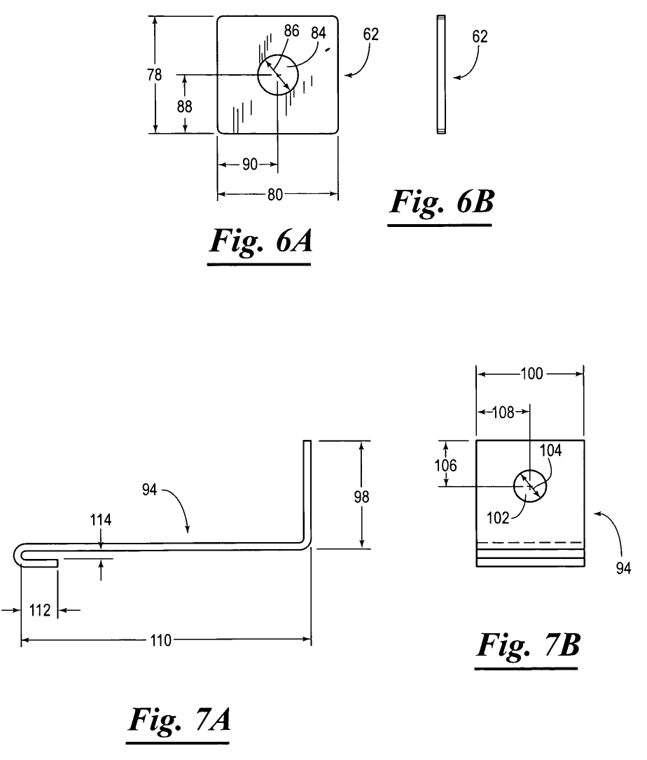

Referring now to FIGS. 6A and 6B, the anchor fastener 62 is dimensioned to fit in the end of the support member 20 and accept the anchoring bolt 56. One embodiment of the anchor fastener 62 has a length 78, a width 80, an anchoring hole 84 with an anchoring hole width 86, a length to center 88, and a width to center 90. While a square-shape with a circular opening is shown, other shapes, such as but not limited to a c-shape or a ring-shape are sufficient, depending on the shape of the support member 20. In one embodiment suitable for a military vehicle, such as the HEMTT or the PLS, the anchor fastener 62 has the width 80 of 1.50 inches, the length 78 of 1.50 inches, the width to center 90 of 0.75 inches, the length to center 88 of 0.75 inches, and the anchoring hole width 86 of 0.50 inches.

The roof engaging means 54 is any suitable means for engaging the roof, such as, but not limited to, clamps, clips, glue, hangers, hooks, interlocking edges, keyed edges, magnetism, pegs, rivets, suction cups, tabs, ties, velcro, weld, and the like. The roof engaging means 54 shown in FIG. 2 includes a clamp assembly 92 and an anchor clip 94. The anchor clip 94 is capable of engaging a flat portion of the back edge 12 of the roof 6, thereby securing one of the support assemblies 14 (14a as shown in FIG. 2) thereto, and is preferably constructed of a rigid material, such as but not limited to ASTM A653 Steel, 12 gauge. The embodied clamp assembly 92 is capable of engaging an exposed portion of a frame 96 of the roof 6, thereby securing one of the support assemblies 14 (14b as shown in FIG. 2) thereto. While the embodiment shown in FIG. 2 uses the anchor clip 94 and the clamp assembly 92, it should be understood that several configurations of the roof engaging means 54 are possible, including but not limited to two anchor clips 94 or two clamp assemblies 92.

Referring to FIGS. 7A and 7B, the anchor clip 94 is shaped such that it can be connected to the support member 20, as shown if FIG. 2. In one embodiment, the anchor clip 94 is shaped such that it can also be properly fitted with the anchor spacers 60 and connected via the anchoring bolt 56 to the support member 20, as shown in FIG. 2, and such that the back edge 12 of the roof 6 of the vehicle can be properly engaged. In the embodiment shown, the anchor clip 94 has a depth 98, a width 100, an anchoring hole 102 with an anchoring hole width 104, a depth to center 106, and a width to center 108. Referring now to FIG. 7B, the embodied anchor clip 94 has a length 110, a lip length 112, and a catch space 114. In one embodiment suitable for a military vehicle, such as the HEMTT, the anchor clip 94 has the anchoring hole width 104 of 0.44 inches, the length 110 of 4.00 inches, the width 100 of 1.50 inches, the width to center 108 of 0.75 inches, the depth 98 of 1.50 inches, the depth to center 106 of 0.65 inches, the lip length 112 of 0.50 inches, and the catch space 114 of 0.10 inches.

As shown in FIG. 2, the clamp assembly 92 has means for engaging the roof 6. As embodied, the clamp assembly 92 engages the exposed portion of the frame 96 of the roof 6. The clamp assembly 92 may be any means for engaging the roof 6, including but not limited to brackets, clamps, clips, glue, hangers, hooks, interlocking edges, keyed edges, magnets, rivets, suction cups, ties, velcro, weld and the like. One embodiment suitable for a military vehicle, such as the HEMTT, has a clamp bolt 116, two half clamps 118, a clamp nut 120, and two clamp washers 122. The half clamps 118 are preferably constructed of a rigid material, such as but not limited to ASTM A653 Steel, 12 gauge. While this embodiment uses a clamp bolt 116, a clamp nut 120, and two clamp washers 122 to connect the two half clamps 118, any suitable connecting means would suffice. For example but not limited to clamps, clips, glue, hooks, magnetism, rivets, ties, velcro, weld and the like.

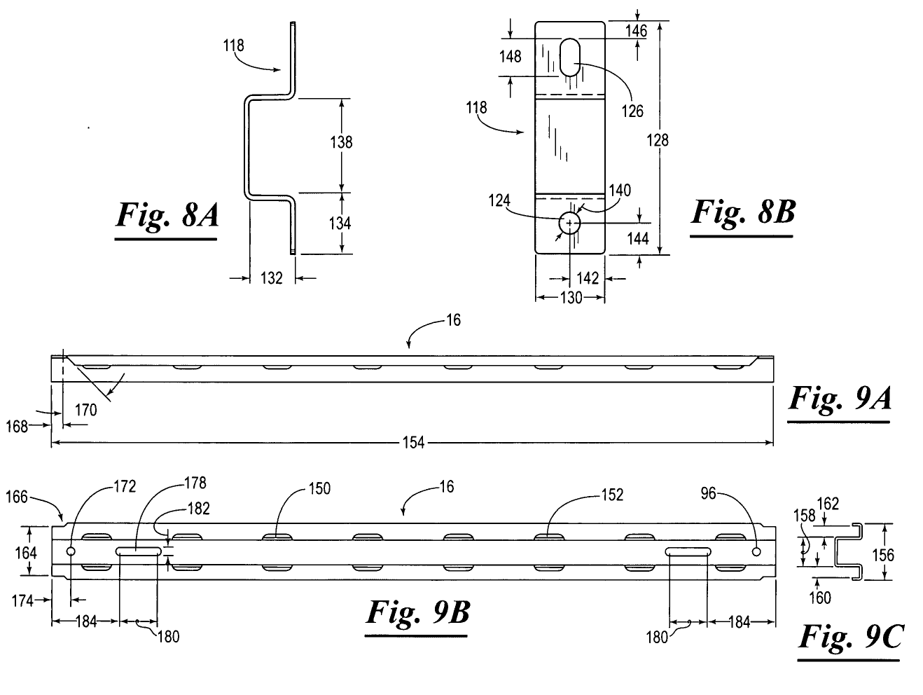

Referring to FIGS. 8A and 8B, the half clamps 118 are shaped so as to be suitable for engaging the roof 6. In the embodiment shown, the half clamps 118 each have a clamping hole 124, an anchoring slot 126, a length 128, a width 130, a depth 132, a clamping tab length 134, and a channel length 138 suitable for engaging the exposed portion of the frame 96 of the roof 6 (shown in FIG. 2). The clamping hole 124 has a clamping hole width 140 through which the clamp bolt 116 can pass. The half clamps 118 have a clamping offset width 142, and a clamping offset length 144 such that the clamp bolt 116 can pass through the two half clamps 118, as shown in FIG. 2. The half clamps 118 also have an anchoring offset length 146, and an anchoring slot length 148 such that the anchoring bolt 44 can pass through the two half clamps 118 as shown in FIG. 2. While the preferred embodiment shows two separate half clamps 118 connected by a clamp bolt 116, other means for connecting the half clamps 118, such as but not limited to a hinged edge, glue, magnetism, rivets, ties, velcro, weld, and the like, are also sufficient. While the half clamps 118 form a specific shape, any shape capable of engaging the roof 6 will suffice. In one embodiment suitable for a military vehicle, such as the HEMTT, the two half clamps 118 have the length 128 of 4.92 inches, the width 130 of 1.50 inches, the depth 132 of 1.00 inches, the clamping tab length 134 of 1.25 inches, the channel length 138 of 2.00 inches, the clamping hole width 140 of 0.44 inches, the clamping offset width 142 of 0.75 inches, the clamping offset length 144 of 0.63 inches, the anchoring offset length 146 of 0.41 inches, and the anchoring slot length 148 of 0.81 inches.

Referring to FIG. 2, in one embodiment suitable for a military vehicle, such as the HEMTT, the two half clamps 118 are situated on either side of the exposed portion of the frame 96 of the roof 6, with the clamping hole 124 (shown in FIG. 8) and anchoring slot 126 of each of the two half clamps 118 aligned and touching. The clamp bolt 116 is threaded through one of the two clamp washers 122, through one of the two half clamps 118, through the other of the two half clamps 118, through the other of the two clamp washers 122 and into the clamp nut 120, and tightened, thereby creating the clamp assembly 92. While a clamping hole 124, a clamp bolt 116, two clamp washers 122, two half clamps 118, and a clamp nut 120 are used to create a clamp assembly 92, other suitable components can be used, such as but not limited to a hinged-ring and a clamp.

Referring to FIG. 2, the embodied lateral supports 16 (identified as 16a, 16b, 16c, and 16d for clarity) are preferably elongated u-shaped channels constructed of a rigid material capable of supporting a load, such as but not limited to ASTM B209-04 Aluminum, 0.125″ thick. However, other shapes are acceptable, such as but not limited to a box-shaped bar, a circular bar, a triangular bar, a plate, and the like.

Referring now to FIGS. 9A and 9B, the embodied lateral supports 16 have a securing mechanism 150 for securing the load 8 (shown in FIG. 1) to the lateral supports 16. The securing mechanism 150 can be any mechanism capable of securing the load 8, such as brackets, clamps, clips, hangers, hooks, magnetism, pegs, suction cups, tabs, ties, velcro, and the like. In one embodiment, the securing mechanism 150 consists one or more securing slots 152 which can accept rope, bungees, or the like to secure the load 8 (shown in FIG. 1) to the lateral supports 16.

Referring now to FIGS. 9A, 9B, and 9C, the lateral supports 16 are sized so as to connect to the support member 20, cover a portion of the roof 6 of the vehicle 2, accommodate the load 8, and distribute it to the support member 20. In one preferred embodiment, the lateral supports 16 are shaped to form a u-shaped channel. The lateral supports 16 have a length 154, an outer width 156, an inner width 158, a first lip width 160, a second lip width 162, an end width 164, a lip cut length 168, and a lip cut taper 170. The lateral supports 16 have one or more mounting holes 172 with a mounting hole inset 174 such that a mounting bolt 176 can pass through any of the mounting holes 172 (as shown in FIG. 2). The lateral supports 16 have one or more mounting slots 178 with a mounting slot length 180, a mounting slot width 182, and a mounting slot inset 184 such that the mounting bolt 176 can pass through any of the mounting slots 178. While the embodiment shown is a u-shaped channel, any means suitable to connect the support member 20, cover a portion of the roof 6 of the vehicle 2, accommodate the load 8, and distribute it to the support member 20 is sufficient. For example, but not limited to a circular bar, a triangular bar, a box-shaped bar, a plate, and the like. In one embodiment suitable for a military vehicle, such as the HEMTT or the PLS, the lateral supports 16 have the length 154 of 48.00 inches, the outer width 156 of 3.63 inches, the inner width 158 of 1.88 inches, the first lip width 160 of 0.75 inches, the end width 164 of 3.17 inches, the mounting hole inset 174 of 1.25 inches, the mounting slot length 180 of 2.50 inches and the mounting slot width 182 of 0.50 inches, the mounting slot inset 184 of 4.50 inches, the lip cut length 168 of 0.75 inches, and the lip cut taper 170 of 45°.

As shown in FIG. 2, the mounting mechanisms 18 join the lateral supports 16 to the support assemblies 14. One embodiment of the mounting mechanisms 18 has the mounting bolt 176, one or more mounting washers 186, and a mounting nut 188. The mounting holes 26 in the support member 20 (shown in FIG. 3), the mounting holes 172 in the lateral supports 16 (shown in FIG. 9), and the mounting slot 178 in the lateral supports 16 (shown in FIG. 9) allow the mounting bolt 176 and the mounting nut 188 to secure the lateral supports 16 to the support member 20. The mounting bolt 176 is threaded through one of the mounting washers 186, through one of the mounting holes 172 or the mounting slots 178 in the lateral supports 16, through one of the mounting holes 26 in the support member 20, through another of the mounting washers 186, and into the mounting nut 188. The mounting bolt 176 and the mounting nut 188 are then tightened to secure the lateral supports 16 to the support member 20. While this embodiment uses the mounting bolt 176, the mounting washers 186, the mounting holes 172 or the mounting slots 178, the mounting holes 26, and the mounting nut 188 to connect the lateral supports 16 to the support assemblies 14, any suitable connecting means would suffice. For example: brackets, clamps, clips, glue, hangers, hooks, interlocking edges, keyed edges, magnetism, pegs, rivets, suction cups, tabs, ties, velcro, weld, and the like.

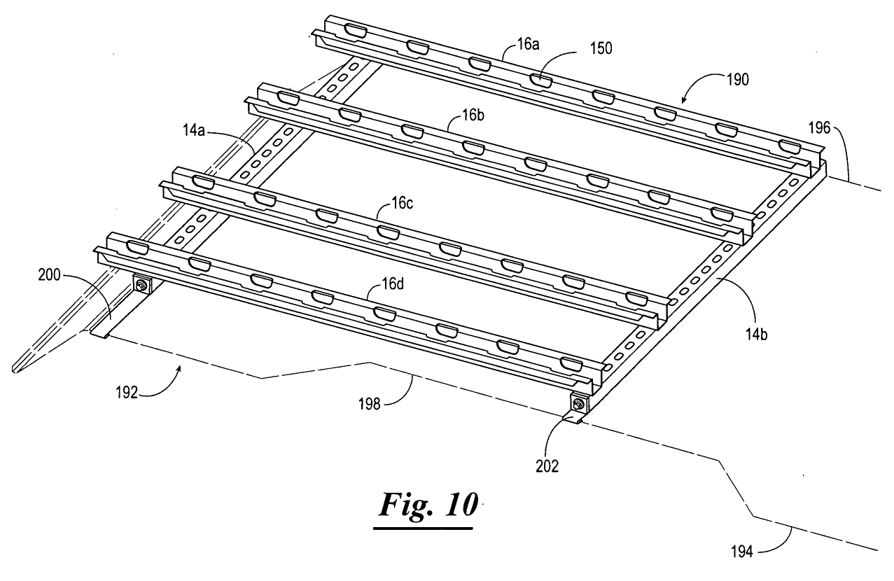

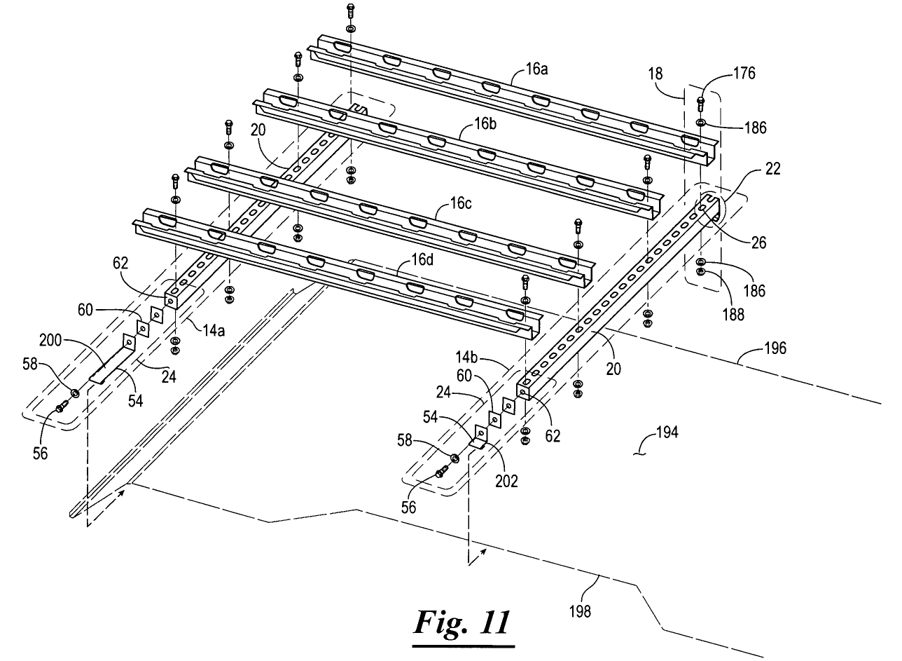

Referring now to FIGS. 10 and 11, an alternate embodiment of the invention is a roof rack 190 that may be used with an alternate vehicle 192, such as the PLS, having a roof 194 with a front edge 196 and a back edge 198. The roof rack 190 is similar in construction and function as the roof rack 4, except that the roof rack 190 is provided with anchor clips 200 and 202 which differ from the anchor clip 94 and the clamp assembly 92 of the roof rack 4. The anchor clips 200 and 202 are sized and shaped to accommodate the size and shape of the roof 194 of the alternate vehicle 192, particularly the back edge 198. The anchor clips 200 and 202 are each capable of engaging a flat portion of the back edge 198 of the roof 194, thereby securing the support assemblies 14a and 14b thereto, and are preferably constructed of a rigid material, such as but not limited to ASTM A653 Steel, 12 gauge.

Referring to FIGS. 12A and 12B, the anchor clip 200 has a depth 204, a width 206, an anchoring hole 208 with an anchoring hole width 210, a depth to center 212, and a width to center 214 such that the anchor clip 200 can be properly fitted with the anchor spacers 60 and connected via the anchoring bolt 56 to the support member 20, as shown in FIG. 11. Referring now to FIG. 12B, the anchor clip 200 has a length 216, a lip length 218, and a catch space 220 such that the back edge 198 of the roof 194 of the alternate vehicle 192 can be properly engaged. In one embodiment suitable for a military vehicle, such as the PLS, the anchor clip 200 has the anchoring hole width 210 of 0.44 inches, the length 216 of 8.00 inches, the width 206 of 1.50 inches, the width to center 214 of 0.75 inches, the depth 204 of 1.50 inches, the depth to center 212 of 0.75 inches, the lip length 218 of 0.50 inches, and the catch space 220 of 0.10 inches.

Referring to FIGS. 13A and 13B, the anchor clip 202 has a depth 222, a width 224, an anchoring hole 226 with an anchoring hole width 228, a depth to center 230, and a width to center 232 such that the anchor clip 202 can be properly fitted with the anchor spacers 60 and connected via the anchoring bolt 56 to the support member 20, as shown in FIG. 11. Referring now to FIG. 13B, the anchor clip 202 has a length 234, a lip length 236, and a catch space 238 such that the back edge 198 of the roof 194 of the alternate vehicle 192 can be properly engaged. In one embodiment suitable for a military vehicle, such as the PLS, the anchor clip 202 has the anchoring hole width 228 of 0.44 inches, the length 234 of 1.25 inches, the width 224 of 1.50 inches, the width to center 232 of 0.75 inches, the depth 222 of 1.50 inches, the depth to center 230 of 0.65 inches, the lip length 236 of 0.50 inches, and the catch space 220 of 0.10 inches.

The embodied roof racks 4 and 190 shown for the vehicle 2 and the alternate vehicle 192 are substantially the same, with the only difference being the rear anchor assemblies 24. The rear anchor assemblies 24 for the vehicle 2 and the alternate vehicle 192 are all fairly small and inexpensive, and the roof racks 4 and 190 can be constructed from a single kit. This kit contains the components necessary to construct either roof rack 4 or roof rack 190, with parts common to both embodiments, as well as the clamp assembly 92 and the anchor clip 94 for the vehicle 2, and the anchor clips 200 and 202 for the alternate vehicle 192. This allows for an adjustable/interchangeable roof rack which can fit different vehicles. For use with the vehicle 2, the user can discard the anchor clips 200 and 202. Likewise, when the kit is used for the alternate vehicle 192, the clamp assembly 92 and the anchor clip 94 can be discarded. The kit provides the necessary components to construct either the roof rack 4 for the vehicle 2, or the roof rack 190 for the alternate vehicle 192. However, minor modifications in any or all of the components would make the invention suitable for other vehicles as well.

The roof racks 4 and 190 shown cover only a portion of the roofs 6 and 194. Minor modifications in any or all of the components would allow for greater coverage. Additionally, multiple roof racks 4 and 192 may be used on a single roof to maximize coverage.

Installation of the embodiments shown requires only a socket set, with no drilling or welding necessary. However, parts may be connected by any practical means such as but not limited to glue, magnetism, rivets, ties, velcro, weld, and the like.

As shown, the roof racks 4 and 190 allow unobstructed air flow to the engine vent at the rear of the roofs 6 and 194—even with the load 8 in place.

While specific dimensions are given, with minor modifications this invention can be used on other vehicles, both military and civilian. The figures are not necessarily to scale and certain features and certain views of the figures may be shown exaggerated in scale or in schematic in the interest of clarity and conciseness.

It will be understood from the foregoing description that various modifications and changes may be made in the preferred and alternative embodiments of the present invention without departing from its true spirit.

This description is intended for purposes of illustration only and should not be construed in a limiting sense. The scope of this invention should be determined only by the language of the claims that follow. The term “comprising” within the claims is intended to mean “including at least” such that the recited listing of elements in a claim are an open group. “A,” “an” and other singular terms are intended to include the plural forms thereof unless specifically excluded.

What is claimed is:

1. A roof rack connectable to a roof of a vehicle, the roof having a front edge and a back edge, the roof rack comprising:
at least one support member for supporting a load on the roof of the vehicle; and
means for engaging the front edge and the back edge of the roof for connecting the support member to the roof.

2. The roof rack of claim 1, wherein the means for engaging comprises at least one anchor assembly.

3. The roof rack of claim 1, wherein the means for engaging does not mar the vehicle.

4. The roof rack of claim 1, wherein the roof rack is adaptable to fit different vehicles.

5. The roof rack of claim 1, wherein the vehicle is a military vehicle.

6. The roof rack of claim 1, further comprising:
at least one lateral support, coupled to the support member.

7. The roof rack of claim 1, wherein the roof rack covers only a section of the roof of the vehicle.

8. The roof rack of claim 6, wherein the lateral support is connectable to the support member in more than one location.

9. A vehicle with at least one roof rack of claim 1.

10. A kit for constructing a roof rack connectable to a roof of a vehicle, the roof having a front edge and a back edge, the kit comprising:
at least one support member for supporting a load on the roof of the vehicle; and
means for engaging the front edge and the back edge of the roof for connecting the support member to the roof which when combined produce a roof rack.

11. The kit of claim 10, further comprising alternate means for engaging the front edge and the back edge of the roof, such that the kit may be used for more than one vehicle.

12. The kit of claim 10 further comprising:
at least one lateral support.

13. A method of connecting a roof rack to a roof of a vehicle, comprising:
providing at least one support member for supporting a load on the roof of the vehicle, and a means for engaging the front edge and the back edge of the roof for connecting the support member to the roof; and
engaging the front edge and the back edge of the roof to connect the support member to the roof.
